(19) United States
(12) Patent Application Publication
(10) Pub. No.: US 2009/0301648 A1
(43) Pub. Date: Dec. 10, 2009

(54) TIGHT CONSTELLATION COMPOSITE TAPE-LAYING MACHINE

(76) Inventors: Merrill Wilson Hogg, Maple Valley, WA (US); Allen Bradley Hagen, Auburn, WA (US)

Correspondence Address: DUKE W. YEE, YEE & ASSOCIATES, P.C., P.O. BOX 802333, DALLAS, TX, 75380, US

(21) Appl. No.: 12/133,754

(22) Filed: Jun. 5, 2008

(51) Int. Cl. B29C 70/30

(52) U.S. Cl. 156/230; 156/433

(57) ABSTRACT

An apparatus for laying tape on a workpiece. The apparatus includes a constellation frame and a first tape-laying head comprising a first compaction roller attached to constellation frame such that the first compaction roller can have a five axis motion with respect to the constellation frame. A second tape-laying head comprising a second compaction roller may be attached to the constellation frame such that the second compaction roller can have a five axis motion with respect to the constellation frame that is independent of the motion of the first tape-laying head.

### BACKGROUND INFORMATION

1. Field

The present disclosure relates generally to machines for applying composite materials. More particularly, the present disclosure relates to an apparatus for applying tape to contoured surfaces.

2. Background

Composite structures such as those used in the automotive, marine and aerospace industries may be fabricated using automated composite material application machines, commonly referred to as automated fiber placement (AFP) machines. AFP machines may be used in the aircraft industry, for example to fabricate structural shapes and skin assemblies by wrapping relatively narrow strips of composite, slit tape or “tows”, collimated into a wider band, around a manufacturing tool. The AFP machine aligns and places a plurality of tape strips, typically six or more, in continuous, edge to edge contact forming a single wide, conformal bandwidth which is placed on and compacted against the tool.

Thus, the composite lay-up includes one or more layers of tape, with each layer being formed from touching and/or overlapping strips of the material. A resin, which may be pre-impregnated in the material or later injected into one or more of the layers of material, can be processed after layup to cure the composite lay-up such that the tape strips may be consolidated. At the end of the curing process, the raw object may be formed. In some cases, the raw object may be further processed in order to make the object more suitable for an intended purpose.

However, especially in the aircraft construction industry, at least two problems present themselves with respect to tape-laying machines. First, existing AFP machines do not lay the large volumes of tape needed to construct a large aircraft component such as a wing or fuselage quickly enough. Second, some objects to be constructed from composite materials may be contoured and even highly contoured. For example, the leading edge of a wing may have a precise, highly-curved shape. In some cases, the shape of the object to be constructed can be both highly contoured and irregular, such as, perhaps, in the case of stringers, frames, spars and/or other support structures.

Existing methods for making highly contoured composite components are generally limited to hand layup techniques, braid/resin infusion fabrication, and the use of automated fiber placement (AFP) machines, however each of these techniques has disadvantages. For example, hand layup requiring manual placement of narrow bands of material into multi-leg shapes is both costly and time consuming, and therefore may be only suitable for prototyping activities and small production runs. Similarly, a known technique in which fibers are braided to form contoured shapes and then infused with resin is also time consuming and may produce components that exhibit qualities not suited to high performance applications, including added weight.

Accordingly, there is a need for an automatic fiber placement apparatus that can lay the large volumes of tape needed to construct large aircraft components quickly. There is also a need for an apparatus for laying up contoured and even highly contoured surfaces.

### SUMMARY

An embodiment of the present disclosure provides for an apparatus for laying tape on a workpiece. The apparatus includes a constellation frame and a first tape-laying head comprising a first compaction roller attached to constellation frame such that the first compaction roller can have five axis motion with respect to the constellation frame. A second tape-laying head comprising a second compaction roller may be attached to the constellation frame such that the second compaction roller can have five axis motion with respect to the constellation frame. The second tape-laying head can have five axis motion that is independent of five axis motion of the first tape-laying head.

An embodiment of the present disclosure provides for a method for laying tape on a workpiece. The method includes laying tape on the workpiece using an apparatus. The apparatus includes a constellation frame and a plurality of tape-laying heads attached to the constellation frame such that each of the plurality of tape-laying heads independently have five axis motion with respect to the constellation frame.

An embodiment of the present disclosure provides for an apparatus for laying tape on a tool. The apparatus includes a gantry machine with X and Y axes of travel that exceed outer dimensions of the tool. A cluster of three or more tape-laying heads attaches to the gantry, the cluster having a multi-head array. The connection between the multi-head array and the gantry may have yaw, pitch, and roll rotational capability for moving the tape-laying heads normal to a surface of the tool, on which the tape may be laid. Each of the three or more tape-laying heads may have further movement capability to allow movement of each of the tape-laying heads to be fine-tuned individually depending on a contour of the tool. The three or more tape-laying heads may be in proximity to one another such that each tape-laying head may be within a distance approximately equal to a width of a tape, or multiple tapes, for which a corresponding tape-laying head may be designed to hold. Each of the three or more tape-laying heads may be self contained, with each of the three or more tape-laying heads having a corresponding different supply of tape.

### BRIEF DESCRIPTION OF THE DRAWINGS

The novel features believed characteristic of the advantageous embodiments may be set forth in the appended claims. The advantageous embodiments, however, as well as a preferred mode of use, further objectives and advantages thereof, will best be understood by reference to the following detailed description of an advantageous embodiment of the present disclosure when read in conjunction with the accompanying drawings, wherein:

FIG. 1 shows a flow diagram of aircraft production and service method; and

FIG. 2 shows a block diagram of an aircraft;

FIG. 3 shows a functional diagram of a tape-laying machine for use in applying tape to a workpiece, in accordance with an advantageous embodiment;

FIG. 4 shows a tape-laying machine for use in applying tape to a workpiece, in accordance with an advantageous embodiment;

FIG. 5 shows a view of a constellation frame for a tape-laying machine, in accordance with an advantageous embodiment;

FIG. 5A shows a magnified portion of a tape laying head shown in FIG. 5, in accordance with an advantageous embodiment;

FIG. 6 shows a view of a constellation frame for a tape-laying machine, in accordance with an advantageous embodiment;

FIG. 7 shows a view of a constellation frame for a tape-laying machine, in accordance with an advantageous embodiment;

FIG. 8 shows a view of a constellation frame for a tape-laying machine, in accordance with an advantageous embodiment;

FIG. 9 shows a view of a tape-laying head for a constellation frame for a tape-laying machine, in accordance with an advantageous embodiment;

FIG. 10 shows a view of a tape-laying head for a constellation frame for a tape-laying machine, in accordance with an advantageous embodiment.

FIG. 11 shows a view of a tape-laying head for a constellation frame for a tape-laying machine, in accordance with an advantageous embodiment;

FIG. 12 shows a tape-laying machine for use in applying tape to a workpiece, in accordance with an advantageous embodiment;

FIG. 13 shows a flowchart illustrating a process of operating a tape-laying machine, in accordance with an advantageous embodiment;

### DETAILED DESCRIPTION

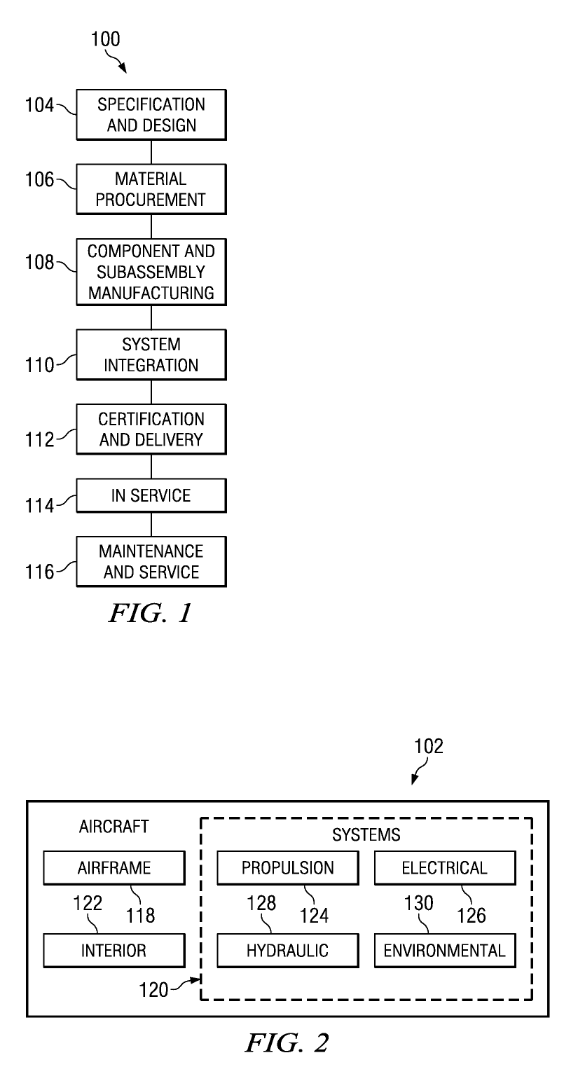

Referring more particularly to the drawings, embodiments of the disclosure may be described in the context of an aircraft manufacturing and service method 100 as shown in FIG. 1 and an aircraft 102 as shown in FIG. 2. During pre-production, exemplary method 100 may include specification and design 104 of the aircraft 102 and material procurement 106. During production, component and subassembly manufacturing 108 and system integration 110 of the aircraft 102 takes place. Thereafter, the aircraft 102 may go through certification and delivery 112 in order to be placed in service 114. While in service by a customer, the aircraft 102 is scheduled for routine maintenance and service 116 (which may also include modification, reconfiguration, refurbishment, and so on).

Each of the processes of method 100 may be performed or carried out by a system integrator, a third party, and/or an operator (e.g., a customer). For the purposes of this description, a system integrator may include without limitation any number of aircraft manufacturers and major-system subcontractors; a third party may include without limitation any number of venders, subcontractors, and suppliers; and an operator may be an airline, leasing company, military entity, service organization, and so on.

As shown in FIG. 2, the aircraft 102 produced by exemplary method 100 may include an airframe 118 with a plurality of systems 120 and an interior 122. Examples of high-level systems 120 include one or more of a propulsion system 124, an electrical system 126, a hydraulic system 128, and an environmental system 130. Any number of other systems may be included. Although an aerospace example is shown, the principles of the invention may be applied to other industries, such as the automotive industry.

Apparatus and methods embodied herein may be employed during any one or more of the stages of the production and service method 100. For example, components or subassemblies corresponding to production process 108 may be fabricated or manufactured in a manner similar to components or subassemblies produced while the aircraft 102 is in service. Also, one or more apparatus embodiments, method embodiments, or a combination thereof may be utilized during the production stages 108 and 110, for example, by substantially expediting assembly of or reducing the cost of an aircraft 102. Similarly, one or more of apparatus embodiments, method embodiments, or a combination thereof may be utilized while the aircraft 102 is in service, for example and without limitation, to maintenance and service 116.

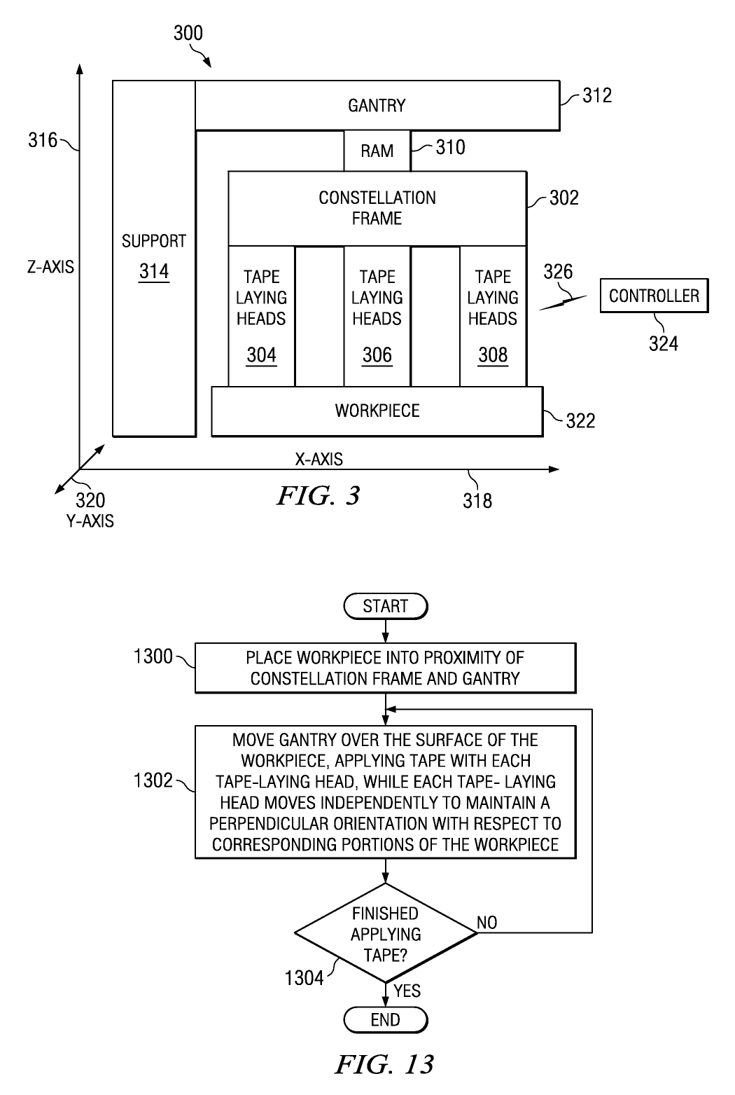

FIG. 3 shows a functional block diagram of a tape-laying machine for use in applying tape to a workpiece, in accordance with an advantageous embodiment. Tape-laying apparatus 300 includes constellation frame 302, to which may be attached tape-laying head 304, tape-laying head 306, and tape-laying head 308. Tape-laying head 304, tape-laying head 306, and tape-laying head 308 can be characterized as first, second, or third tape laying heads, though not necessarily in that order. Ram 310 connects constellation frame 302 to gantry 312. Gantry 312 is attached to support 314. In an illustrative example, ram 310 can be considered part of tape-laying apparatus 300. In another illustrative example, both ram 310 and gantry 312 can be considered part of tape-laying apparatus 300.

In an illustrative example, constellation frame 302 can have five axis motion with respect to gantry 312. Five axis motion includes one or more of extension upwardly and downwardly along Z axis 316, translation along Y axis 318 and X axis 330, pitch motion with respect to gantry 312 (rotation about Y axis 318), and yaw motion with respect to gantry 312 (rotation about X axis 320). In another illustrative example, constellation frame 302 can have two axis motion with respect to gantry 312. In this particular example, two axis motion includes pitch motion with respect to gantry 312, and yaw motion with respect to gantry 312. However, tape-laying apparatus 300 can be designed to have any one or more of the described five axes of motion with respect to gantry 312. In an illustrative example, motion of constellation frame 302 with respect to gantry 312 may be independent of any motion of gantry 312 with respect to support 314.

In another illustrative embodiment, each of tape-laying head 304, tape-laying head 306, and tape-laying head 308 can move independently with respect to each other and with respect to any motion of constellation frame 302, gantry 312, or support 314. For example, each of tape-laying heads 304, 306, and 308 can have up to five-axis motion with respect to constellation frame 302. Thus, in one example, each of tape-laying heads 304, 306, and 308 can move up and down with respect to constellation frame 302, translate along X and Y axes with respect to constellation frame 302, pitch with respect to constellation frame 302, and yaw with respect to constellation frame 302—all independent of any motion of constellation frame 302 with respect to gantry 312 and independent of any motion of gantry 312 with respect to support 314. In another illustrative example, each of tape-laying heads 304, 306, and 308 can have different degrees of freedom of movement. For example, with respect to constellation frame 302, tape-laying head 304 could have two axis motion, tape-laying head 306 could have three axis motion, and tape-laying head 308 could have five axis motion.

The degrees of freedom present in tape-laying apparatus 300 allow the corresponding facing work surfaces of tape-laying head 304, tape-laying head 306, and tape-laying head 308 to be normal to corresponding areas of the surface of work piece 322. In this manner, tape can be applied evenly and rapidly to the surface of work piece 322. In this example, workpiece 322 may be considered to be a template, which can be a frame, skeleton, or surface of some object, such as an aircraft component.

In an illustrative example, work piece 322 can be replaced by a mandrel. In this case, a composite lay-up may be produced by laying tape on the mandrel. When the composite lay-up may be completed, the composite lay-up can be removed from the mandrel for further processing.

The motions of each of constellation frame 302, tape laying head 304, tape laying head 306, tape laying head 308, ram 310, gantry 312, and possibly support 314 may be controlled by one or more control devices and/or software programs represented by controller block 324. One or more components of controller block 324 may be directly, indirectly, or wirelessly connected to any one or more of constellation frame 302, tape laying head 304, tape laying head 306, tape laying head 308, ram 310, gantry 312, and possibly support 314, as shown by connection representation 326. The one or more components of controller block 324 may exchange signals with any of the components of tape-laying apparatus 300 in order to provide for feedback control of the motion of those components and of the application of tape to workpiece 322. The one or more control devices and/or software programs of controller block 324 may be implemented using a variety of devices and computer usable program code, including but not limited to sensors (such as but not limited to sensors for measuring positions of components of tape-laying apparatus 300, sensors to measuring the amount of dispensed tape, and other sensors), databases, mechanical or electrical linkages, busses, processors, and tape-laying algorithms. The one or more software programs can use input from sensors to implement a feedback loop in order to determine how to apply to tape and/or to determine when to end the tape laying process.

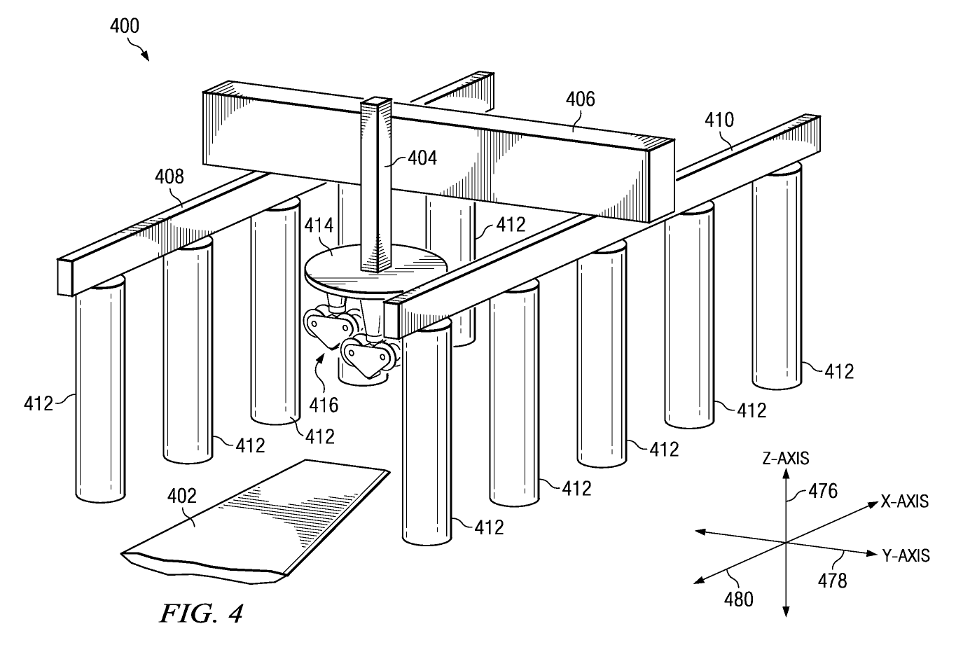

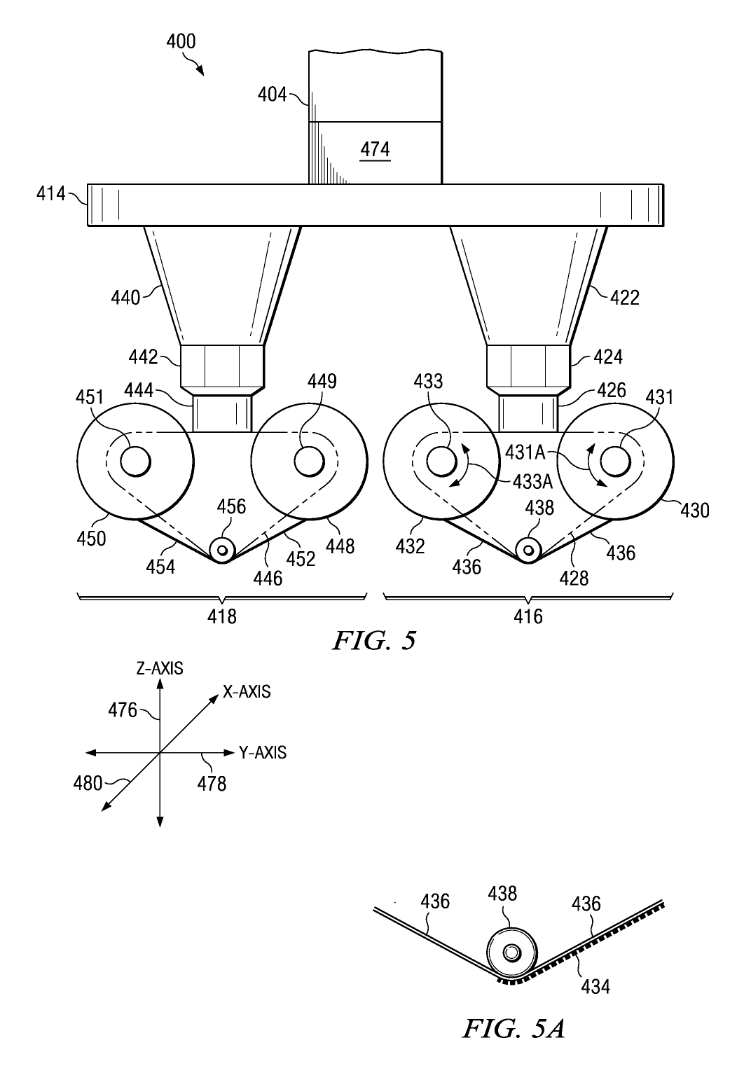

In the following figures, similar reference numerals in different figures refer to the same component. Thus, for example, tape-laying apparatus 400 in FIG. 5 refers to the same tape-laying apparatus 400 shown in FIG. 4. Tape-laying apparatus 400 can also be referred-to as a tape laminating machine. As used herein, the terms “connect,” “mount,+ “attach,” and similar terms mean that a physical connection exists between the described objects; however, such connection could be through or via an intermediate object.

FIG. 4 shows a tape-laying machine for use in applying tape to a workpiece, in accordance with an advantageous embodiment. The tape-laying machine shown in FIG. 4 includes tape-laying apparatus 400 for use in applying tape to workpiece 402. In this illustrative example, workpiece 402 may be, without limitation, a wing of an aircraft. Workpiece 402 can be characterized as a tool. However, workpiece 402 can be any object upon which tape may be applied.

Tape-laying apparatus 400 may be attached to ram 404. Ram 404 may be a rod, beam, shaped object, or any other structure suitable for supporting constellation frame 414. In turn, ram 404 may be attached to gantry 406. Gantry 406 may be a rod, beam, shaped object, or any other structure suitable for supporting ram 404. Gantry 406 may be slidably attached to first rail 408 and second rail 410 such that gantry 406 can slide back and forth along first rail 408 and second rail 410. First rail 408 and second rail 410 may be supported by columns 412 or by any other suitable support mechanism. Thus, tape-laying apparatus 400 may be suspended over work piece 402.

In an illustrative example, workpiece 402 may be itself supported on a column or on some apparatus that can rotate, translate, or otherwise move work piece 402 such that tape-laying apparatus 400 can access every portion of workpiece 402.

Tape-laying apparatus 400 includes constellation frame 414, which holds a constellation of tape-laying heads, such as tape-laying head 416. Constellation frame constellation frame 414, in the shown illustrative example, may be a disk. However, constellation frame 414 can be any shape or structure suitable for supporting multiple tape-laying heads.

In an illustrative example, constellation frame 414 may be attached to ram 404 in such a manner that constellation frame 414 can have five axis movement, as described with respect to tape-laying apparatus 300 in FIG. 3. In an illustrative example, constellation frame 414 may be attached to ram 404 such that constellation frame 414 can roll (rotation about Z axis 476), with respect to ram 404, thereby creating six-axis movement. In still another illustrative example, constellation frame 414 can translate along the long axis of ram 404 (translation along Z axis 476). In yet another illustrative example, constellation frame 414 can be attached to ram 404 in such a manner as to allow a combination of two or more of these forms of motion.

Similarly, ram 404 can be attached to gantry 406 in such a manner as to allow ram 404 to translate with respect to one or more of the primary axes of gantry 406. The primary axes of gantry 406 are Y axis 478 and X axis 480. Additionally, gantry 406 can be attached to first rail 408 or second rail 410 in such a manner as to allow translation of gantry 406 with respect to one of the primary axes of gantry 406. Note that Z axis 476, Y axis 478, and X axis 480 can be considered first, second, and third axes. The labeling of axes is for convenience only. Any of the axes labels could be interchanged, so long as the corresponding movement is consistent with this description. Thus, possibly, first, second, third, or further tape-laying heads, or together or separately their sub-components, could be characterized as moving along any particular axis. Additionally, polar coordinates or other coordinate systems could be used to describe the movement of any tape laying head or together or separately its sub-components.

FIG. 5 shows a view of a constellation frame for a tape-laying machine, in accordance with an advantageous embodiment. Constellation frame 414 may be shown attached to ram 404 for reference. The relative freedom of tape-laying apparatus 400 to comply with the contour of work piece 402 can be further enhanced using yaw, pitch, and roll rotation assembly 474. Yaw, pitch, and roll rotation assembly 474 may be attached to constellation frame 414 and ram 404 such that constellation frame 414 can pitch (rotation about Y axis 478), roll (rotation about Z axis 476), and/or yaw (rotation about X axis 480) with respect to ram 404.

Constellation frame 414 may be used to support a constellation of tape-laying heads, such as tape-laying head 416 and tape-laying head 418. The term “constellation,” as used herein, refers to a grouping of two or more objects, and may be used to refer to two or more tape-laying heads. Placing multiple tape-laying heads onto a single constellation frame 414 allows more tape to be applied to a workpiece, relative to the amount of available area on tape-laying apparatus 400. In illustrative examples described herein, constellation frame 414 holds three tape-laying heads; however, in other illustrative examples, constellation frame 414 can mount two tape-laying heads, more than two tape-laying heads, or possibly even one tape-laying head.

Each tape-laying head mounted to constellation frame 414 includes a variety of components used for applying or laying tape to workpiece 402. For example, tape-laying head 416 includes translation and rotation mount 422, which may be attached to constellation frame 414. As shown, translation and rotation mount 422 may have a rhomboid shape; however, translation and rotation mount 422 can be any structure of any shape suitable for securing translation and rotation mount 422 to constellation frame 414. Translation and rotation mount 422 can translate along Y axis 478 and X axis 480 relative to constellation frame 414 and can further rotate about Z axis 476 relative to constellation frame 414. In this manner, compaction roller 438 can translate and rotate relative to constellation frame 414. Additionally, the distance between tape-laying head 416 and tape-laying head 418 can be translationally and rotationally varied about one or more of Z axis 476, Y axis 478, and X axis 480, relative to constellation frame 414, during operation of tape-laying apparatus 400.

Mount 424 is also attached to translation and rotation mount 422. Mount 424 provides a convenient coupling mechanism between mount 424 and piston 426. However, in other illustrative examples, piston 426 can be connected directly to translation and rotation mount 422.

In an illustrative example, mount 424 may be a hexagonal structure attached to translation and rotation mount 422 such that mount 424 can have five axis movement and/or rotate with respect to translation and rotation mount 422 and constellation frame 414. However, mount 424 can be any structure of any shape suitable for attaching head frame 428 to translation and rotation mount 422 in such a way as to allow head frame 428 to have five axis motion and/or rotate with respect to translation and rotation mount 422 and constellation frame 414. In other illustrative examples, mount 424 may be fixedly attached to translation and rotation mount 422.

In the illustrative example of FIG. 5, piston 426 is attached to mount 424. Piston 426 translates up and down along Z axis 476. Piston 426 is also attached to head frame 428. Thus, the motion of piston 426 allows compaction roller 438 to be translated along Z axis 476. Note that the term “piston” is used; however, any desirable mechanism for extending and retracting compaction roller 438 relative to constellation frame 414 can be used in place of piston 426.

In an illustrative example, one or more of translation and rotation mount 422, mount 424, and piston 426 may be excluded from tape-laying head 416. For example, if a particular type of motion were not needed for an application, then the corresponding component could be excluded. Additionally, other mechanisms for providing five or more axis movement can be provided.

Head frame 428 may be a structure used to support supply reel 430, spindle 431, carrier paper take-up reel 432, and spindle 433. Spindle 431 and spindle 433 may be attached to head frame 428, while supply reel 430 and carrier paper take-up reel 432 can be placed onto spindle 431 and spindle 433, respectively. Supply reel 430 may be used to hold a reel of tape 434. In an illustrative example, one side of tape 434 may be attached to carrier paper 436 in order to facilitate operation of tape-laying apparatus 400. Carrier paper 436 may be threaded under compaction roller 438 and thence may be attached to carrier paper take-up reel 432. Tape 434 can be considered any of first, second, or third tapes, with each tape laying head having one or more sections of tape. Carrier paper 436 can be considered any of first, second, or third carrier papers, with each tape laying head having one or more sections of carrier paper.

In use, tape 434 may be applied to work piece 402 using compaction roller 438. The surface of tape 434 opposite the surface abutting carrier paper 436 may be applied to workpiece 402. As tape-laying head 416 moves along the surface of workpiece 402, supply reel 430 unwinds tape 434 so that continuing movement of tape-laying head 416 applies more tape to workpiece 402. Carrier paper take-up reel 432 takes up the remaining carrier paper 436, resulting in carrier paper 436 being wound around carrier paper take-up reel 432. Compaction roller 438 facilitates operation of tape-laying head 416 by allowing carrier paper 436 to smoothly roll under the apex of head frame 428. In this manner, supply reel 430 and carrier paper take-up reel 432 can each rotate rapidly 431A and 433A about spindle 431 and spindle 433, respectively, in order to rapidly apply tape to workpiece 402.

Tape-laying head 418 may have a similar structure to tape-laying head 416. Thus, for example, translation and rotation mount 440 can be attached to constellation frame 414. In this manner, the distance between tape-laying head 416 and tape-laying head 418 can be varied during operation of tape-laying apparatus 400. In an illustrative example, the motion of translation and rotation mount 440 relative to constellation frame 414 may be independent of the motion of translation and rotation mount 422 relative to constellation frame 414. Translation and rotation mount 440 can be attached to mount 442 in such a manner as to allow mount 442 to have five axis motion and/or rotate with respect to translation and rotation mount 440 and constellation frame 414. Translation and rotation mount 422, mount 424, and translation and rotation mount 440 can be characterized as first, second, and third mounts, though not necessarily in that order.

Piston 444 may be attached to mount 442 such that head frame 446 can move inwardly and outwardly with respect to mount 442, translation and rotation mount 440, and constellation frame 414 (the long axis of tape-laying head 418). Piston 444 may be attached to head frame 446. Supply reel 448 may be removably attached to spindle 449, which may be in turn attached to head frame 446. Carrier paper take-up reel 450 may be removably attached to spindle 451, which may be in turn attached to head frame 446. Tape 452, together with carrier paper 454, may be attached to supply reel 448. Carrier paper 154 may be threaded under compaction roller 456 and may be thence attached to carrier paper take-up reel 450 such that carrier paper take-up reel 450 can take up carrier paper 454 as tape 452 may be applied to workpiece 402.

Tape-laying head 418 operates in a similar manner to tape-laying head 416. However, each component of tape-laying head 418 can operate independently of each component tape-laying head 416. In this manner, tape-laying head 416 and tape-laying head 418 can each move such that each individual tape-laying head may be placed normal (perpendicular) to a contoured, perhaps irregular, surface of work piece 402. If desired, each individual tape-laying head may be placed at any desired angle with respect to a contoured, perhaps irregular, surface of work piece 402.

In an illustrative example, the operational speeds of supply reel 430 and carrier paper take-up reel 432 may be substantially the same as the operational speeds of supply reel 448 and carrier paper take-up reel 450. In this manner, tape-laying head 416 may run out of tape 434 at the same time that tape-laying head 418 runs out of tape 452, assuming that the amount and type of tape on supply reel 430 may be the same as the amount and type of tape on supply reel 448. However, in other illustrative examples, the operational speeds of these components can be independent of each other. In an illustrative embodiment, the operational speeds of tape-laying heads 416 and 418 are varied independently so that each corresponding supply real is expended at about the same time, or closely in time. In this manner, all reels can be replaced at once to increase the efficiency of the tape-laying operation.

FIG. 5A shows a magnified portion of a tape laying head shown in FIG. 5, in accordance with an advantageous embodiment. Compaction roller 438 in FIG. 5A is the same as compaction roller 438 of tape-laying head 416 shown in FIG. 5. Similarly, the other reference numerals in FIG. 5A correspond to similar reference numerals in FIG. 5.

As shown in FIG. 5A, tape 434 is peeled from carrier paper 436 as tape 434 moves around compaction roller 438. In this manner, tape is applied to the surface of a workpiece.

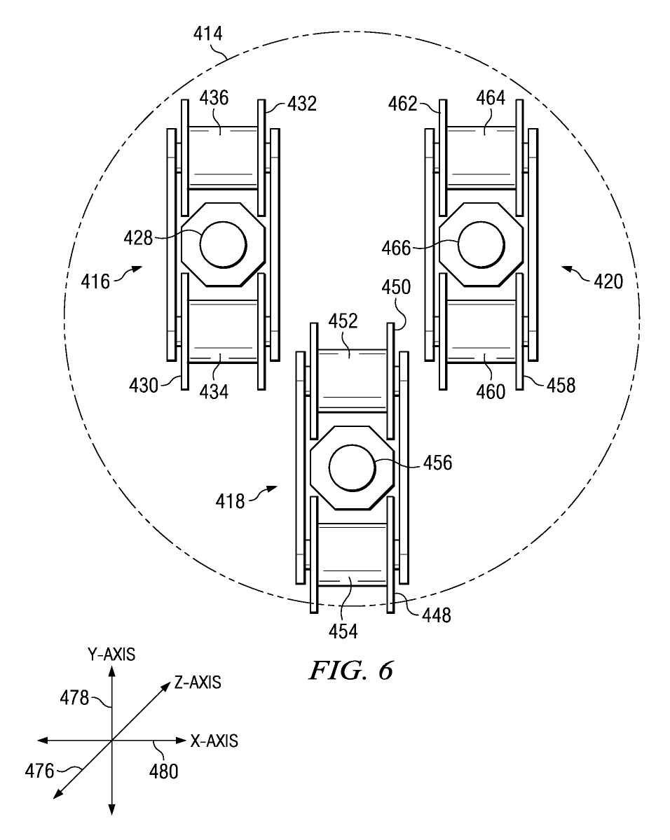

FIG. 6 shows a view of a constellation frame for a tape-laying machine, in accordance with an advantageous embodiment. Z axis 476, Y axis 478, and X axis 480 are shown for reference. Note that Z axis 476 and Y axis 478 appear to be reversed with respect to each other relative to FIG. 5 in order to show a different view of tape-laying apparatus 400.

In this illustrative example, constellation frame 414 supports three tape-laying heads, tape-laying head 416, tape-laying head 418, and tape-laying head 420. Tape-laying head 416, tape-laying head 418, and tape-laying head 420 can be characterized as first, second, and third tape-laying heads, but not necessarily in that order. Each of these tape-laying heads can operate independently of each other, in the manner described with respect to FIG. 5.

Thus, tape-laying head 420 operates independently of tape-laying head 416 and tape-laying head 418. Like the other two tape-laying heads, tape-laying head 420 includes supply reel 458 and carrier paper take-up reel 462. Carrier paper 464, together with tape 460, may be wound around supply reel 458. Carrier paper 464 may be threaded under compaction roller 466, and thence may be attached to carrier paper take-up reel 462. The operation of tape-laying head 420 may be similar to the operation of tape-laying head 418 and tape-laying head 416. Note that supply reel 430, supply reel 448, and supply reel 458 can be considered first, second, and third supply reels, though not necessarily in that order. Note that carrier paper take-up reel 432, carrier paper take-up reel 450, and carrier paper take-up reel 462 can be characterized as first, second, and third carrier paper take-up reels, though not necessarily in that order.

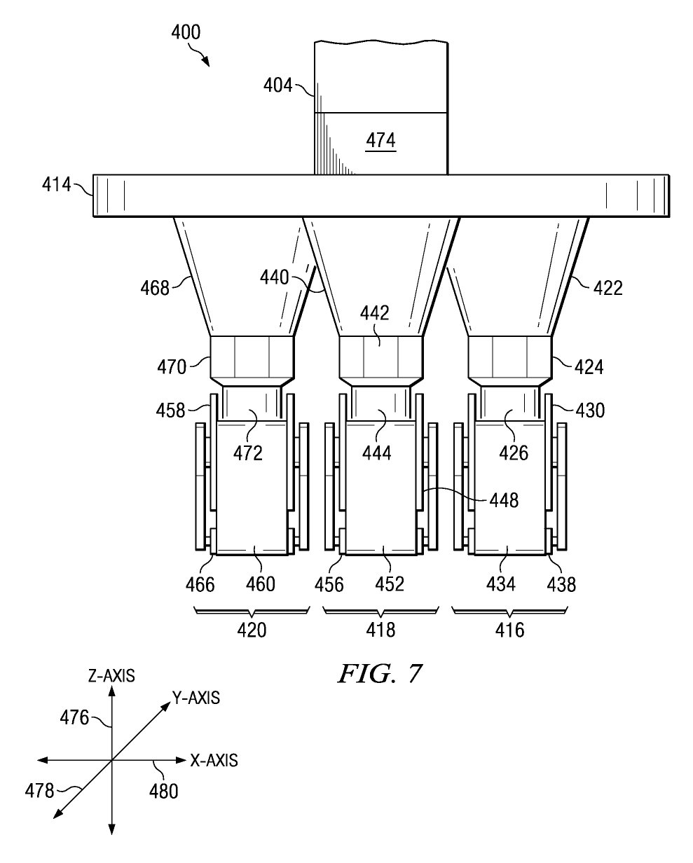

FIG. 7 shows a view of a constellation frame for a tape-laying machine, in accordance with an advantageous embodiment. Z axis 476, Y axis 478, and X axis 480 are shown for reference. Note that Y axis 478 and X axis 480 appear to be reversed with respect to each other relative to FIG. 5 in order to show a different view of tape-laying apparatus 400.

Similarly, ram 404 and yaw, pitch, and roll rotation assembly 474 are shown for reference. Constellation frame 414 supports three tape-laying heads, tape-laying head 416, tape-laying head 418, and tape-laying head 420. FIG. 7 shows that tape-laying head 420, like the other two tape-laying heads, includes translation and rotation mount 468 attached to constellation frame 414. Mount 470 can be attached to translation and rotation mount 468 such that mount 470 can have five axis motion and/or rotate with respect to constellation frame 414. Piston 472 can be attached to mount 470 such that piston 472 can translate along the long axis of tape-laying head 420 with respect to translation and rotation mount 468, mount 470, and constellation frame 414. Tape-laying head 416 facilitates the application of tape 460 to workpiece 402 by allowing carrier paper 464 to roll smoothly under the apex of tape-laying head 420. Piston 426, piston 444, and piston 472 can be characterized as first, second, and third pistons, though not necessarily in that order.

FIG. 8 shows a view of a constellation frame for a tape-laying machine, in accordance with an advantageous embodiment. Z axis 476, Y axis 478, and X axis 480 are shown for reference. Note that Y axis 478 and X axis 480 appear to be reversed with respect to each other relative to FIG. 5 in order to show a different view of tape-laying apparatus 400.

Specifically, FIG. 8 shows the independent operation of each tape-laying head on constellation frame 414. Thus, for example, tape-laying head 416, tape-laying head 418, and tape-laying head 420 each may have a different orientation with respect to constellation frame 414. The term “orientation” refers to relative positions among two or more objects relative to Z axis 476, Y axis 478, and X axis 480. Additionally, each compaction roller may be at a different distance along the long axis of the respective tape-laying heads, with respect to constellation frame 414. Thus, each compaction roller, compaction roller 438, compaction roller 456, and compaction roller 466, may be oriented perpendicular to (or normal to) a corresponding portion of the surface of workpiece 402. Compaction roller 438, compaction roller 456, and compaction roller 466 may be considered first, second, and third compaction rollers, though not necessarily in that order.

In use, the orientation of each of tape-laying head 416, tape-laying head 418, and tape-laying head 420 can change with respect to constellation frame 414 so that each corresponding compaction roller remains normal to whatever portion of the surface of workpiece 402 happens to be facing the corresponding compaction roller. In other words, the independent motion of the three tape-laying heads allows tape to be applied evenly and smoothly over the surface of workpiece 402, even if the surface of workpiece 402 may be curved and/or irregular. Stated still differently, each of tape-laying head 416, tape-laying head 418, and tape-laying head 420 can simultaneously have different orientations with respect to each other, different orientations with respect to constellation frame 414, and different orientations with respect to ram 404.

Additionally, because several tape-laying heads may be simultaneously mounted on constellation frame 414, the total quantity of tape per unit time that can be laid on workpiece 402 may be substantially increased relative to known tape-laying machines. The increased time efficiency reduces the time and cost of the process of applying tape to workpiece 402.

To further increase this efficiency, the spacing of the tape-laying heads with respect to each other can be made relatively narrow. In an illustrative example, the distance between tape-laying heads may be about equal to or less than the width of the tape which each tape-laying head holds. The term “about,” as used herein, means that the value in question can be varied somewhat, less than or equal to 50% to 200% of the original quantity. Thus, for example, the distance between tape-laying heads can be somewhat larger than the width of the tape to be applied to work piece 402, to within 200% of the width of the tape. In another illustrative example, the distance between tape-laying heads can be greater than the width of the tape to be applied to workpiece 402.

To further increase tape-laying efficiency, the tape can be pre-cut. Note that the tape itself may be pre-cut, but the backing paper may not be pre-cut. Pre-cut tape rolled onto a supply reel can be referred-to as cassetted tape. By pre-cutting the tape at selected, pre-determined lengths along the supply reel, tape need not be cut by the tape-laying apparatus itself. Thus, tape can be applied more quickly and more evenly. Additionally, the tape-laying apparatus may be simpler if the tape-laying apparatus does not need a tape cutting tool or tape cutting assembly of parts.

To further increase tape-laying efficiency, the amount of tape on each supply reel can be individually adjusted so that all supply reels will run out of tape at about the same time. In this manner, all supply reels and carrier paper take-up reels can be replaced at the same time. Accordingly, a tape-laying machine need only be stopped once to replace all supply reels and carrier paper take-up reels.

In the case where one or more of tape-laying head 416, tape-laying head 418, and tape-laying head 420 are-attached to constellation frame 414, the distance between each tape-laying head relative to the other tape-laying heads can vary during operation of tape-laying apparatus 400. In this case, the distance between tape-laying head 416 and tape-laying head 418 can be different than the distance between tape-laying head 416 and tape-laying head 420. In this illustrative embodiment, the distance between any two tape-laying heads can vary and need not be set to any pre-determined distance.

The relative freedom of tape-laying apparatus 400 to comply with the contour of workpiece 402 can be further enhanced using yaw, pitch, and roll rotation assembly 474. Yaw, pitch, and roll rotation assembly 474 may be attached to constellation frame 414 and ram 404 such that constellation frame 414 can yaw (rotation about X axis 480), pitch (rotation about Y axis 478), and/or roll (rotation about Z axis 476) with respect to ram 404.

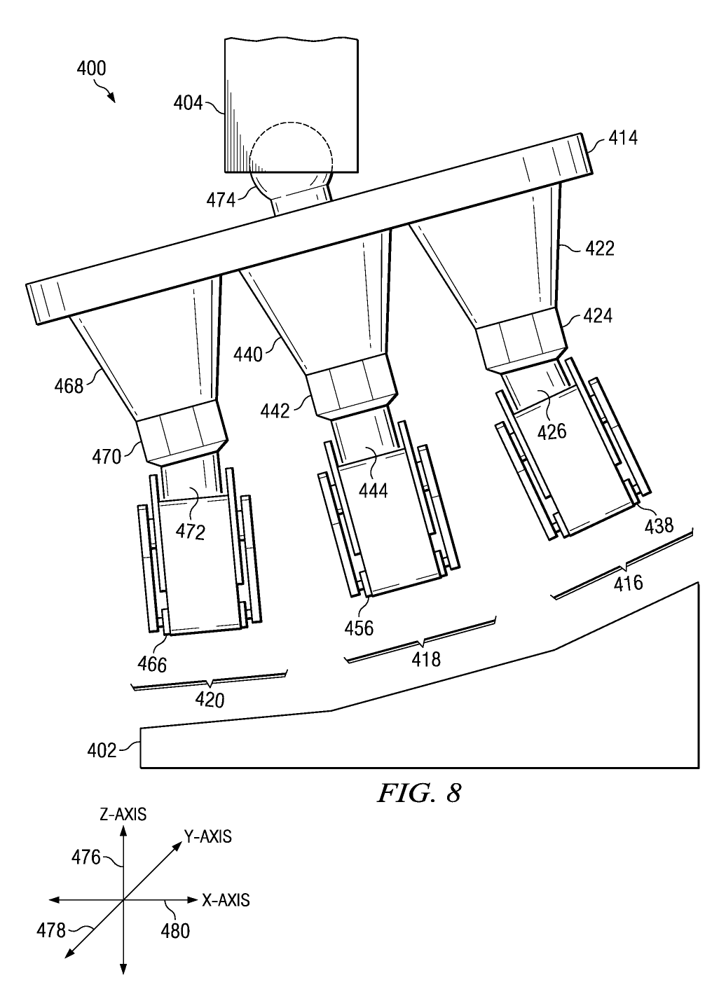

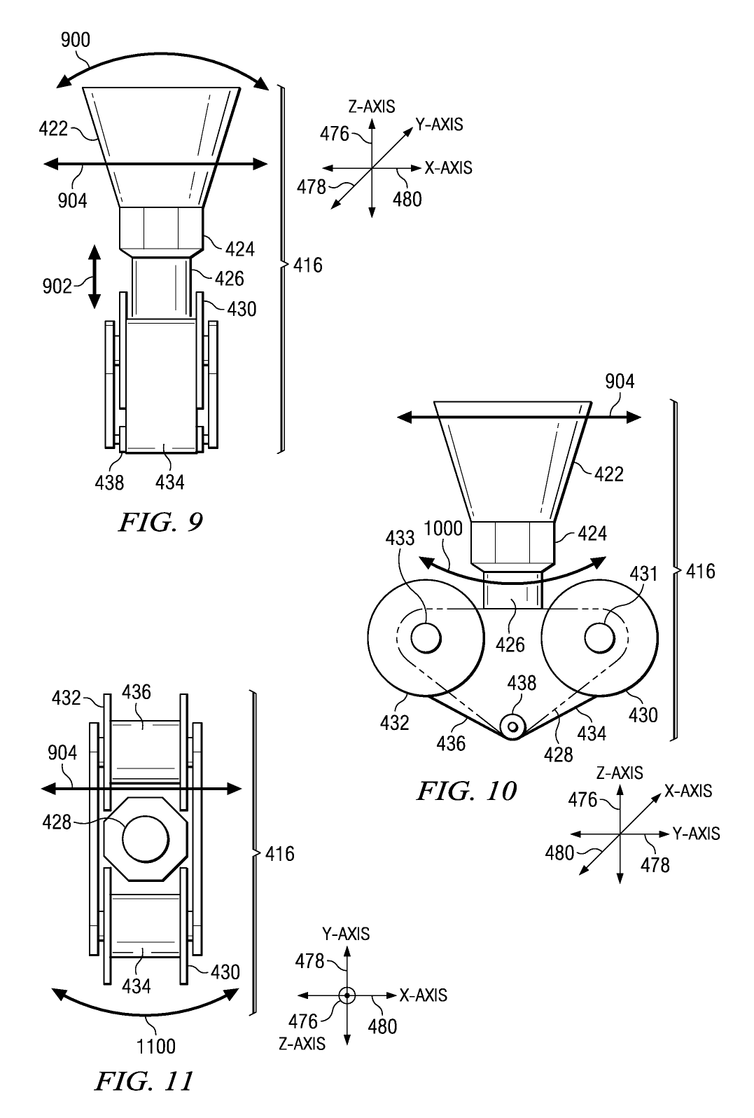

FIG. 9 shows a view of a tape-laying head for a constellation frame for a tape-laying machine, in accordance with an advantageous embodiment. Z axis 476, Y axis 478, and X axis 480 are shown for reference. Note that Y axis 478 and X axis 480 appear to be reversed with respect to each other relative to FIG. 5 in order to show a different view of tape-laying apparatus 400.

Tape-laying head 416 corresponds to tape-laying head 416 shown in FIG. 5. FIG. 9 shows how translation and rotation mount 422 and mount 424 can perform roll rotation (about Y axis 478), as shown by arrows 900. This roll rotation may be used to maintain compaction roller 438 normal (perpendicular) to a work piece.

Similarly, FIG. 9 shows how piston 426 can translate compaction roller 438 along Z axis 476. Lateral translational movement (along Y axis 478), as shown by arrows 904, is used to compensate for roll rotation 900 to keep the pitch of tape application consistent. This motion may be used to maintain compaction roller 438 normal (perpendicular) to a work piece.

Supply reel 430, tape 434, and compaction roller 438 are shown for reference. The remaining features are shown for reference, with reference numerals in FIG. 9 corresponding to similar features in tape-laying head 416 of FIG. 5.

FIG. 10 shows a view of a tape-laying head for a constellation frame for a tape-laying machine, in accordance with an advantageous embodiment. Z axis 476, Y axis 478, and X axis 480 are shown for reference. Note that the orientation of the three axes are the same as the orientation of the three axes shown in FIG. 5.

Tape-laying head 416 corresponds to tape-laying head 416 shown in FIG. 5 and FIG. 9. FIG. 10 shows how translation and rotation mount 422 and mount 424 can perform pitch rotation (rotation about X axis 480), as shown by arrows 1000. Translational motion (along Y axis 478), as with FIG. 9, is shown by arrows 904. These motions may be used to maintain compaction roller 438 normal (perpendicular) to a work piece.

Supply reel 430, carrier paper take-up reel 432, tape 434, carrier paper 436, and compaction roller 438 are shown for reference. The remaining features are shown for reference, with reference numerals in FIG. 10 corresponding to similar features in tape-laying head 416 of FIG. 5.

FIG. 11 shows a view of a tape-laying head for a constellation frame for a tape-laying machine, in accordance with an advantageous embodiment. Z axis 476, Y axis 478, and X axis 480 are shown for reference. Note that Y axis 478 and Z axis 476 appear to be reversed with respect to each other relative to FIG. 5 in order to show a different view of tape-laying apparatus 400.

Tape-laying head 416 corresponds to tape-laying head 416 shown in FIG. 5, FIG. 9, and FIG. 10. FIG. 11 shows that translation and rotation mount 422 and mount 424 can perform yaw motion (rotation about Z axis 476), as shown by arrows 1100. Translational motion (along X axis 480), as with FIG. 9 and FIG. 10 is shown by arrows 904. These motions may be used to maintain compaction roller 438 normal (perpendicular) to a work piece.

Supply reel 430, carrier paper take-up reel 432, tape 434, carrier paper 436, and compaction roller 438 are shown for reference. The remaining features are shown for reference, with reference numerals in FIG. 11 corresponding to similar features in tape-laying head 416 of FIG. 5.

Together, FIG. 4 through FIG. 11 show an apparatus for laying tape on work piece 402 using a five or more axis tape-laying apparatus. The tape-laying apparatus can include gantry 406 with dimensions that exceed outer dimensions of the work piece 402. A cluster of three or more tape-laying heads (416, 418, and 420) attaches to the gantry 406 via constellation frame 414, the cluster being a multi-head array (416, 418, and 420). The connection between the multi-head array (416, 418, and 420) and the gantry 406 may have translational, vertical, and rotational capability for moving the tape-laying heads normal to a surface of the work piece 402. This connection can be the connections among ram 404, constellation frame 414, translation and rotation mount 422, mount 424, piston 426, and head frame 428. Note that either head frame 428 or head frame 446 can be characterized as first and second head frames, but not necessarily in that order.

Each of the three or more tape-laying heads may have further movement capability to allow independent movement of each of the tape-laying heads. Independent movement of the tape-laying heads allows for fine-tuned motion to match a contour of the work piece.

The three or more tape-laying heads may be in proximity to one another such that each tape-laying head may be within a distance approximately equal to a width of a tape, or multiple widths of tape, which a corresponding tape-laying head is designed to hold. Each of the three or more tape-laying heads may be self contained, with each of the three or more tape-laying heads having a corresponding different supply of tape.

Together, FIG. 4 through FIG. 11 show an apparatus 400 for laying tape on a workpiece 402. The apparatus includes a constellation frame 414. The apparatus further includes a first tape-laying head 416 having a first translation and rotation mount 422 attached to the constellation frame 414 and a first compaction roller 428 attached to the first translation and rotation mount 422 such that the first compaction roller 428 can move along multiple axes and/or rotate with respect to the first translation and rotation mount 422. For example, mount 424 can be attached to translation and rotation mount 422 to allow such motion.

The apparatus further includes a second tape-laying head 418 having a second translation and rotation mount 440 attached to the constellation frame 414 and a second compaction roller 456 attached to the second translation and rotation mount 440 such that the second compaction roller 456 can move along multiple axes and/or rotate with respect to the second translation and rotation mount 440 independently of the first tape-laying head 416. For example, mount 442 can be attached to translation and rotation mount 440 to allow such motion.

The various components described with respect to FIG. 3 through FIG. 11 can be characterized as “first,” “second,” “third,” etc., in order to identify different objects. For example, mount 440 can be characterized as a “first mount” and mount 442 can be characterized as a “second mount.”

In this manner, the illustrative embodiments provide for an apparatus for laying tape on a workpiece, the apparatus comprising: a constellation frame; a first tape-laying head comprising a first compaction roller attached to constellation frame such that the first compaction roller can have five axis movement with respect to the constellation frame; and a second tape-laying head comprising a second compaction roller attached to the constellation frame such that the second compaction roller can have five axis movement with respect to the constellation frame independent of the first tape-laying head. In an illustrative example, the first tape-laying head and the second tape-laying head are separated by a distance about equal to one of a width of a tape and a multiple of the width, wherein the tape may be usable by at least one of the first tape-laying head and the second tape-laying head.

In another illustrative example, the first tape-laying head further comprises a first mount attached to the constellation frame and to a second mount. In yet another illustrative example, the first tape-laying head further comprises a first piston attached to the second mount and to the first compaction roller such that the first piston can move along a first axis relative to the second mount, wherein the second tape-laying head further comprises a third mount attached to the constellation frame and to a fourth mount, wherein the second tape-laying head further comprises a second piston attached to the third mount and to the second compaction roller such that the second piston can move along a second axis relative to the third mount, and wherein movement of the first piston may be independent of movement of the second piston.

In yet another illustrative example, the first tape-laying head further comprises a first head frame attached to the first compaction roller, a first supply reel attached to the first head frame, and a first carrier paper take-up reel attached to the first head frame, and wherein the second tape-laying head further comprises a second head frame attached to the second compaction roller, a second supply reel attached to the second head frame, and a second carrier paper take-up reel attached to the second head frame. Still further, this apparatus can comprise a first tape attached to the first supply reel such that the first tape can unroll from the first supply reel, wherein the first tape further comprises first carrier paper attached to the first tape, and wherein the first carrier paper may be threaded under the first compaction roller and thence attached to the first carrier paper take-up reel; and a second tape attached to the second supply reel such that the second tape can unroll from the second supply reel, wherein the second tape further comprises second carrier paper attached to the second tape, and wherein the second carrier paper may be threaded under the second compaction roller and thence attached to the second carrier paper take-up reel.

In another illustrative example, the apparatus includes a ram attached to the constellation frame such that the constellation frame can pitch, yaw and rotate with respect to the ram. In this apparatus, a gantry can be attached to the ram such that the ram can move along the gantry.

In yet another illustrative example, the apparatus includes at least one rail attached to the gantry such that the gantry can move along at least one rail. In this apparatus, at least one column can support the at least one rail. Additionally, the apparatus can comprise a workpiece disposed with respect to the at least one column such that at least one tape-laying head of the constellation frame can touch the workpiece. Alternatively or in addition, the apparatus can comprise a column attached to and supporting the ram.

In another illustrative example, the ram may be attached to the column such that the ram can rotate with respect to the column. In this apparatus, the ram may be attached to the column such that the ram can move translate with respect to the column.

In an illustrative method, tape may be laid on the workpiece using an apparatus, the apparatus comprising: a constellation frame; and a plurality of tape-laying heads attached to the constellation frame such that each of the plurality of tape-laying heads independently rotate, pitch, yaw, and translate with respect to the constellation frame. The method may further include controlling laying of tape on the workpiece using a controller block.

In another illustrative example, the plurality of tape-laying heads are further attached to the constellation frame such that the plurality of tape-laying heads further independently move along corresponding independent axes with respect to the constellation frame. Still further, the work piece comprises a contoured surface and wherein each of the plurality of tape-laying heads moves independently along the corresponding independent axes such that ones of the plurality of tape-laying heads are perpendicular to corresponding portions of the contoured surface.

In another illustrative example, the method includes moving a gantry, the gantry attached to the constellation frame, such that the apparatus moves over the contoured surface. In yet another illustrative example, for each tape-laying head, rotation movement, pitch movement, yaw movement, and translation movement are independently performed with respect to the constellation frame while laying tape. In this illustrative method, the method can further include performing rotation movement, pitch movement, yaw movement, and translation movement with the constellation frame, wherein movement of the constellation frame is independent of movement of each of the plurality of tape-laying heads. In yet another illustrative example, controlling laying of tape comprises using a software program and sensors to implement a feedback loop to determine how tape is laid and to determine when to end laying of tape.

Another illustrative apparatus for laying tape on a tool is included. This illustrative apparatus comprises a gantry machine with at least one axis of travel that exceeds outer dimensions of the tool; a ram connected to the gantry machine, wherein the ram is capable of translational movement with respect to the gantry machine; a cluster of three or more tape-laying heads attached to the ram, the cluster comprising a multi-head array, wherein corresponding ones of the three or more tape-laying heads can maintain corresponding perpendicular orientations to corresponding portions of a surface of the tool on which the tape is laid; wherein each of the three or more tape-laying heads further has movement capability to allow movement of each of the three or more tape-laying heads to be fine-tuned individually depending on a contour of the tool; wherein the three or more tape-laying heads are in proximity to one another such that each tape-laying head is within a distance equal to or less than about a width of a tape, or multiple widths of tape, which a corresponding tape-laying head is designed to hold; and wherein each of the three or more tape-laying heads is self contained, with each of the three or more tape-laying heads having a corresponding different supply of tape.

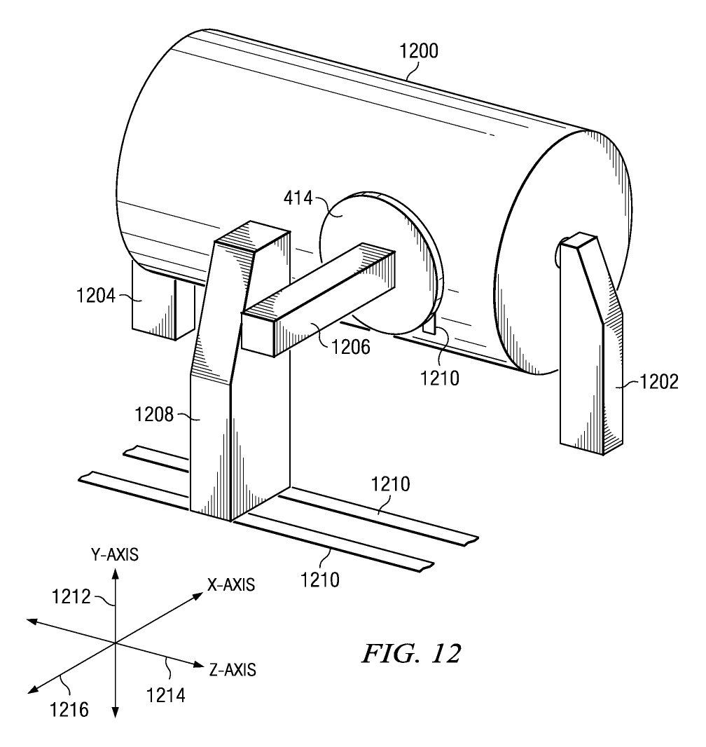

FIG. 12 shows a tape-laying machine for use in applying tape to a workpiece, in accordance with an advantageous embodiment. The arrangement shown in FIG. 12 shows that constellation frame 414 can be attached to different support configurations in order to create different tape-laying apparatuses, relative to tape-laying apparatus 400. Y axis 1212, Z axis 1214, and X axis 1216 are shown for reference.

In this illustrative embodiment, the tape-laying heads may be attached to the side of constellation frame 414 facing mandrel 1200. The structure of constellation frame 414 may be similar to that shown in FIG. 4 through FIG. 11.

Mandrel 1200 may be supported by tail stock 1202 and head stock 1204. Mandrel 1200 can rotate about the long axis of mandrel 1200 (corresponding to Z axis 1214 in the illustrative example of FIG. 12). As mandrel 1200 rotates, the tape-laying heads on constellation frame 414 apply tape 1210 to mandrel 1200 in order to form a composite lay-up (not shown). Ultimately, when the composite lay-up is complete, the composite lay-up can be removed from mandrel 1200 for further processing.

Constellation frame 414 may be supported by ram 1206, which in turn may be supported by column 1208. Constellation frame 414 can be mounted to ram 1206 such that constellation frame 414 can perform one or more of rotation, pitch, yaw, or translation with respect to ram 1206. Similarly, ram 1206 can be mounted to column 1208 such that ram 1206 can translate vertically and/or horizontally with respect to column 1208. Column 1208 can translate along rails 1210.

As described with respect to FIG. 4 through FIG. 11, each tape-laying head can move independently of each other with respect to constellation frame 414. In this manner, if mandrel 1200 had a more irregular shape, a corresponding orientation each of the tape-laying heads on constellation frame 414 can be adjusted so that each tape laying head may be normal to, or have any desired angle with respect to, a corresponding portion of the surface of mandrel 1200. The various components shown in FIG. 12 can be controlled using a controller mechanism, such as controller block 324 shown in FIG. 3.

FIG. 13 shows a flowchart illustrating a process of operating a tape-laying machine, in accordance with an advantageous embodiment. Initially, a work piece is placed into proximity of a constellation frame and gantry (operation 1300). The gantry then moves over the surface of the workpiece, applying tape with each tape-laying head, while each tape-laying head moves independently to maintain a perpendicular orientation with respect to corresponding portions of the work piece (operation 1302).

A software program then makes a determination whether the process of applying tape is finished (operation 1304). A “no” determination results in the process returning to operation 1302 and the tape-laying process continuing. A “yes” determination results in the process terminating.

The software program can take the form of an entirely hardware embodiment, an entirely software embodiment, or an embodiment containing both hardware and software elements. The software program may be implemented as firmware, resident software, microcode, or other forms.

Furthermore, the software program can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system, or a propagation medium. The medium also may be physical medium or tangible medium on which computer readable program code can be stored. Examples of a computer-readable medium include a semiconductor or solid state memory, magnetic tape, a removable computer diskette, a random access memory (RAM), a read-only memory (ROM), a rigid magnetic disk, an optical disk, or some other physical storage device configured to hold computer readable program code. Current examples of optical disks include compact disk-read only memory (CD-ROM), compact disk-read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the data processing system to enable the data processing system to become coupled to other data processing systems or remote printers or storage devices through intervening private or public networks. Modems, cable modem and Ethernet cards are just a few of the currently available types of network adapters.

Thus, an embodiment of the present disclosure provides for a method for laying tape on a workpiece 402. Tape may be laid on the workpiece 402 using an apparatus, such as the tape-laying apparatuses shown in FIG. 4 through FIG. 10. The apparatus used to lay the tape includes a constellation frame 414. The apparatus used to lay the tape also includes a plurality of tape-laying heads (such as, but not limited to 416, 418, and 420) attached to the constellation frame such that each of the plurality of tape-laying heads independently have five axis movement-with respect to constellation frame 414 and further independently move along corresponding independent axes with respect to the constellation frame 414. For example, pistons (such as, but not limited to, piston 426, piston 444, and piston 472) can be used to allow motion of the tape-laying heads to move along corresponding independent axes with respect to the constellation frame 414. In another example, rotatably and/or translatably attached pods (such as, but not limited to, translation and rotation mount 422 and mount 424) can allow the tape-laying heads to independently translate and/or rotate with respect to constellation frame 414.

Further degrees of freedom of movement can be achieved in order to allow each tape-laying head to achieve an orientation normal to a corresponding surface of the workpiece or mandrel. For example, the method can also include moving a gantry, the gantry attached to the constellation frame, such that the apparatus moves over the contoured surface.

The description of the different advantageous embodiments may have been presented for purposes of illustration and description, and may be not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected may be chosen and described in order to best explain the principles of the embodiments, the practical application, and to enable others of ordinary skill in the art to understand the disclosure for various embodiments with various modifications as may be suited to the particular use contemplated.

What is claimed is:

1. An apparatus for laying tape on a workpiece, the apparatus comprising:
a constellation frame;
a first tape-laying head comprising a first compaction roller attached to constellation frame such that the first compaction roller can have five axis movement with respect to the constellation frame; and
a second tape-laying head comprising a second compaction roller attached to the constellation frame such that the second compaction roller can have five axis movement with respect to the constellation frame independent of the first tape-laying head.

2. The apparatus of claim 1 wherein the first tape-laying head and the second tape-laying head are separated by a distance about equal to one of a width of a tape and a multiple of the width, wherein the tape is usable by at least one of the first tape-laying head and the second tape-laying head.

3. The apparatus of claim 1 wherein the first tape-laying head further comprises a first mount attached to the constellation frame and to a second mount.

4. The apparatus of claim 3 wherein the first tape-laying head further comprises a first piston attached to the second mount and to the first compaction roller such that the first piston can move along a first axis relative to the second mount, wherein the second tape-laying head further comprises a third mount attached to the constellation frame and to a fourth mount, wherein the second tape-laying head further comprises a second piston attached to the third mount and to the second compaction roller such that the second piston can move along a second axis relative to the third mount, and wherein movement of the first piston is independent of movement of the second piston.

5. The apparatus of claim 4 wherein the first tape-laying head further comprises a first head frame attached to the first compaction roller, a first supply reel attached to the first head frame, and a first carrier paper take-up reel attached to the first head frame, and wherein the second tape-laying head further comprises a second head frame attached to the second compaction roller, a second supply reel attached to the second head frame, and a second carrier paper take-up reel attached to the second head frame.

6. The apparatus of claim 5 further comprising:
a first tape attached to the first supply reel such that the first tape can unroll from the first supply reel, wherein the first tape further comprises first carrier paper attached to the first tape, and wherein the first carrier paper is threaded under the first compaction roller and thence attached to the first carrier paper take-up reel; and
a second tape attached to the second supply reel such that the second tape can unroll from the second supply reel, wherein the second tape further comprises second carrier paper attached to the second tape, and wherein the second carrier paper is threaded under the second compaction roller and thence attached to the second carrier paper take-up reel.

7. The apparatus of claim 1 further comprising:
a ram attached to the constellation frame such that the constellation frame can pitch, yaw and rotate with respect to the ram.

8. The apparatus of claim 7 further comprising:
a gantry attached to the ram such that the ram can move along the gantry.

9. The apparatus of claim 8 further comprising:
at least one rail attached to the gantry such that the gantry can move along at least one rail.

10. The apparatus of claim 9 further comprising:
at least one column supporting the at least one rail.

11. The apparatus of claim 10 further comprising:
a workpiece disposed with respect to the at least one column such that at least one tape-laying head of the constellation frame can touch the workpiece.

12. The apparatus of claim 8 further comprising:
a column attached to and supporting the ram.

13. The apparatus of claim 12 wherein the ram is attached to the column such that the ram can rotate with respect to the column.

14. The apparatus of claim 12 wherein the ram is attached to the column such that the ram can move translate with respect to the column.

15. A method for laying tape on a workpiece, the method comprising:
laying tape on the workpiece using an apparatus, the apparatus comprising:
a constellation frame; and
a plurality of tape-laying heads attached to the constellation frame such that each of the plurality of tape-laying heads independently rotate, pitch, yaw, and translate with respect to the constellation frame; and;
controlling laying of tape on the workpiece using a controller block.

16. The method of claim 15 wherein the plurality of tape-laying heads are further attached to the constellation frame such that the plurality of tape-laying heads further independently move along corresponding independent axes with respect to the constellation frame.

17. The method of claim 16 wherein the work piece comprises a contoured surface and wherein each of the plurality of tape-laying heads moves independently along the corresponding independent axes such that ones of the plurality of tape-laying heads are perpendicular to corresponding portions of the contoured surface.

18. The method of claim 15 further comprising:
moving a gantry, the gantry attached to the constellation frame, such that the apparatus moves over the contoured surface.

19. The method of claim 15 further comprising:
for each tape-laying head, independently performing yaw, pitch, and roll rotational movement, as well as translation movement, with respect to the constellation frame while laying tape.

20. The method of claim 19 further comprising:
performing yaw, pitch, and roll rotational movement, as well as translation movement, with the constellation frame, wherein movement of the constellation frame is independent of movement of each of the plurality of tape-laying heads.

21. The method of claim 15 wherein controlling laying of tape comprises using a software program and sensors to implement a feedback loop to determine how tape is laid and to determine when to end laying of tape.

22. An apparatus for laying tape on a tool, the apparatus comprising:
a gantry machine with at least one axis of travel that exceeds outer dimensions of the tool;
a ram connected to the gantry machine, wherein the ram is capable of translational movement with respect to the gantry machine;
a cluster of three or more tape-laying heads attached to the ram, the cluster comprising a multi-head array, wherein corresponding ones of the three or more tape-laying heads can maintain corresponding perpendicular orientations to corresponding portions of a surface of the tool on which the tape is laid;
wherein each of the three or more tape-laying heads further has movement capability to allow movement of each of the three or more tape-laying heads to be fine-tuned individually depending on a contour of the tool;
wherein the three or more tape-laying heads are in proximity to one another such that each tape-laying head is within a distance equal to or less than about a width of a tape, or multiple widths of tape, which a corresponding tape-laying head is designed to hold; and
wherein each of the three or more tape-laying heads is self contained, with each of the three or more tape-laying heads having a corresponding different supply of tape.
